(19) United States
(12) Patent Application Publication
(10) Pub. No.: US 2014/0236657 A1
(43) Pub. Date: Aug. 21, 2014

(54) METHOD AND DEVICE FOR PROCESSING USER GENERATED CONTENT

(71) Applicant: TENCENT TECHNOLOGY (SHENZHEN) COMPANY LIMITED, Shenzhen (CN)

(72) Inventors: Zhu Liang, Shenzhen (CN); Xin Feng, Shenzhen (CN)

(73) Assignee: TENCENT TECHNOLOGY (SHENZHEN) COMPANY LIMITED, Shenzhen (CN)

(21) Appl. No.: 14/263,795

(22) Filed: Apr. 28, 2014

Related U.S. Application Data
(63) Continuation of application No. PCT/CN2012/086616, filed on Dec. 14, 2012.

(30) Foreign Application Priority Data
Dec. 16, 2011 (CN) 201110422780.5

(51) Int. Cl. G06Q 10/10

(52) U.S. Cl. CPC G06Q 10/1093
USPC 705/7.18

(57) ABSTRACT

Described are a method and a device for processing a user generated content (UGC). The method includes: providing an interface; receiving a calendar entry establishment request of a user, and establishing a calendar entry on the interface; searching for a UGC matching the calendar entry on the interface, and displaying the UGC on the interface; receiving a selection command for selecting the UGC from the interface, and associating the UGC selected with the calendar entry; displaying the calendar entry and information of the UGC associated with the calendar entry on the interface. The device correspondingly includes: a calendar entry establishing module, a UGC searching module, an associating module, and a calendar entry displaying module

### CROSS-REFERENCE TO RELATED APPLICATIONS

This application is a continuation application of PCT Patent Application No. PCT/CN2012/086616, entitled “METHOD AND DEVICE FOR PROCESSING USER GENERATED CONTENT”, field on Dec. 14, 2012, which claims the priority benefit of Chinese Patent Application No. 201110422780.5 field on Dec. 16, 2011, both of which are incorporated by reference herein in their entirety.

### TECHNICAL FIELD

The present disclosure relates to network information processing technology field, and specifically, to a method and a device for processing a user generated content (UGC).

### BACKGROUND

With the development of the Internet technology, the Internet gradually becomes an important source for people to obtain information. Users are not only the browsers of website, but also the producers of the website, especially after the Internet enters the area of Web2.0. The content generated by the users is known as user generated content (UGC), such as, blog articles, photos posted by the users etc.

In the existing social network system, the presentation of the UGC mainly includes two ways. One way is presented in classification, such as, a blog catalogue is configured to present blog articles, album catalogue is configured to present photos, and video catalogue is configured to present videos etc. The other way is present in a simple time online, that is, a presentation order of the UGC is generated in time order.

### SUMMARY

In view of this, the present disclosure provides a method for processing the UGC to reduce times of man machine interaction when the user browses several related UGCs and saves a network resource.

The technology solution of present disclosure is realized as:

a method for processing a user generated content (UGC), at a device having one or more processors and a memory for storing one or more programs to be executed by the one or more process, includes:

providing an interface, receiving a calendar entry establishment request of a user, and establishing a calendar entry on the interface;

searching for a UGC matching the calendar entry, displaying the UGC on the interface;

receiving a selection command for the selecting the UGC from the interface, and associating the UGC selected with the calendar entry; and

displaying the calendar entry and information of the UGC associated with the calendar entry on the interface.

A device for processing a user generated content (UGC), the device comprises one or more processors, a memory storing one or more program modules configured for execution by the one or more processors, the one or more program modules including instructions for:

a calendar entry establishing module, configured to provide an interface, receive a calendar entry establishment request of a user to establish a calendar entry on the interface;

a UGC searching module, configured to search for a UGC matching the calendar entry, and display the UGC on the interface;

an associating module, configured to receive a selection command for selecting the UGC by the user from the interface, and associate the UGC selected with the calendar entry;

a calendar entry displaying module, configured to display the calendar entry and information of the UGC associated with the calendar entry on the interface;

In the embodiment of present disclosure, several related UGC are associated by establishing calendar entry, the information associated with the calendar entry is displayed when the calendar entry is displayed. Each event can be represented by one calendar entry, thus, several fragmented UGCs are gathered in event. It is convenience for the user to browse several UGCs related with a same event. The times of man machine interaction is reduced when the user browses the several UGCs related with a same event, and the network resource is saved.

### BRIEF DESCRIPTION OF THE DRAWINGS

In order to illustrate technical solutions according to embodiments of the disclosure, the drawings to be used in the description of the embodiments of the disclosure will be described briefly hereinafter. The drawings described hereinafter include only some embodiments related to the present disclosure. Other drawings may be determined by those skilled in the art based on these drawings without any creative effort.

FIG. 1 is a schematic diagram of a calendar entry according to an embodiment of present disclosure.

FIG. 2 is a flow chart of a method for processing a UGC according to an embodiment of present disclosure.

FIG. 3 is a schematic diagram of an interface establishing a calendar entry according to an embodiment of present disclosure.

FIG. 4 is a schematic diagram of an interface displaying a found matched UGC when establishing a calendar entry according to an embodiment of present disclosure.

FIG. 5a and FIG. 5b are schematic diagrams of interfaces displaying a calendar entry and information of the UGC associated with the calendar.

FIG. 6 is a schematic diagram of an interface noticing the user to establish a calendar entry.

FIG. 7 is a schematic diagram of an interface inquiring and displaying an established calendar entry.

FIG. 8 is a structure schematic diagram of a device for processing the UGC according to an embodiment of present disclosure.

FIG. 9 is a structure schematic diagram of a device for processing the UGC according to an embodiment of present disclosure.

### DETAILED DESCRIPTION OF ILLUSTRATED EMBODIMENTS

Further description of present disclosure will be illustrated, which combined with embodiments in drawings and detailed embodiments.

According to the presentation of the UGC in typical technology, several UGCs of a same event are split respectively and presented respectively. For example, if a user wants to describe a trip, many kinds of UGC may be posted, such as posting multiple items of microblog content, writing one or second weblogs, or uploading many trip pictures through mobile phone or personal computer (PC) many times. The processing way in typical technology, the UGCs are only presented in a fragmented way, which is presented in UGC catalogue, or presented in establishing time of the UGCs. Regardless presenting in any way, other UGCs are mixed in, the multiple UGCs may not be combined in the same event. When the user or the friends of the user want to browse the UGCs of a same event, they need to search the UGCs related with the same event (for example, a trip) from huge amount of UGCs of multiple kinds. The operation is difficult and the times of man machine interaction increase dramatically. Each time of the man machine interaction, operation requesting information is requested, calculation process is trigged, and response result information is generated that many resource is occupied (such as client resource, server resource, broadband resource).

In order to solve the problem described above, a method for processing UGC is provided in the embodiment of present disclosure. In the method provided in the embodiment of present disclosure, the calendar entry is established, several related UGCs are associated, and the calendar entry is displayed when the associated UGCs are displayed. Each event can be represent by one calendar entry, thus, several fragmented UGCs are gathered in event. It is convenience for the user to browse several UGCs related with a same event. The times of man machine interaction is reduced when the user browses the several UGCs related with a same event, and the network resource is saved.

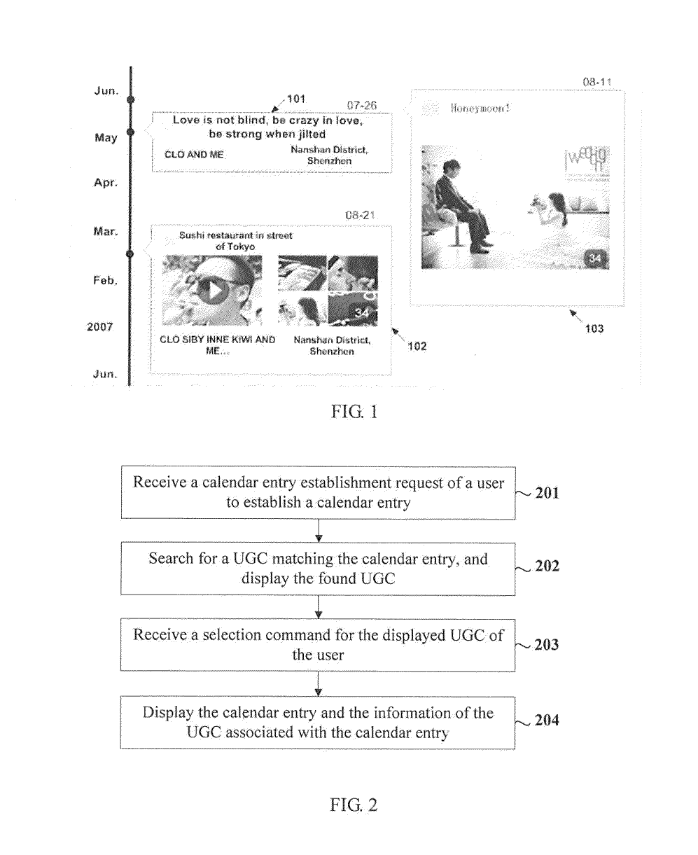

A calendar entry may include time information and textual description in the embodiment of present disclosure. In order to establish a calendar entry, the system may notice the user to input time information and textual description. The time information and the textual description input by the user are recorded by the system to generate a calendar entry with the time information and the textual description. Of course, when the calendar entry is established, the system further notices the user to input geographical information to generate a calendar entry with time information, textual description and geographical information. Of course, when the calendar entry is established, the system may only notice the user to input the geographical information to generate a calendar entry with the geographical information. FIG. 1 is a schematic diagram of a calendar entry according to an embodiment of present disclosure. Referring to FIG. 1, every display box 101,102,103 is a calendar entry, and an establishing time of each calendar entry is in the upper right corner.

Because calendar entry includes time information and textual description input by the user, each event can be represented by a calendar entry. The calendar entry severs as a point of convergence in the embodiment of present disclosure, and a UGC collection labeled with event by associating related UGC together, thus, it is convenience for the user to browse.

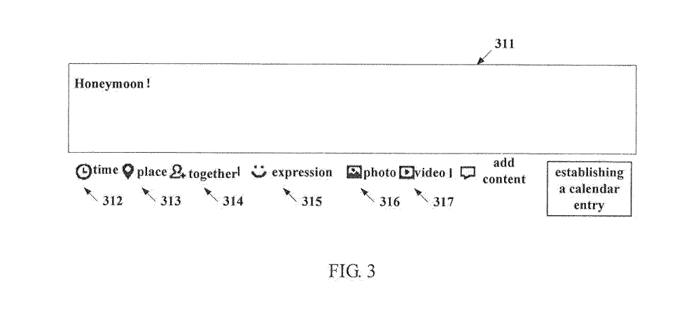

FIG. 2 is a flow chart of a method for processing a UGC according to an embodiment of present disclosure. Referring to FIG. 2, the flow chart is described as below.

Step 201, providing an interface, receiving a calendar entry establishment request of a user and establishing a calendar entry on the interface.

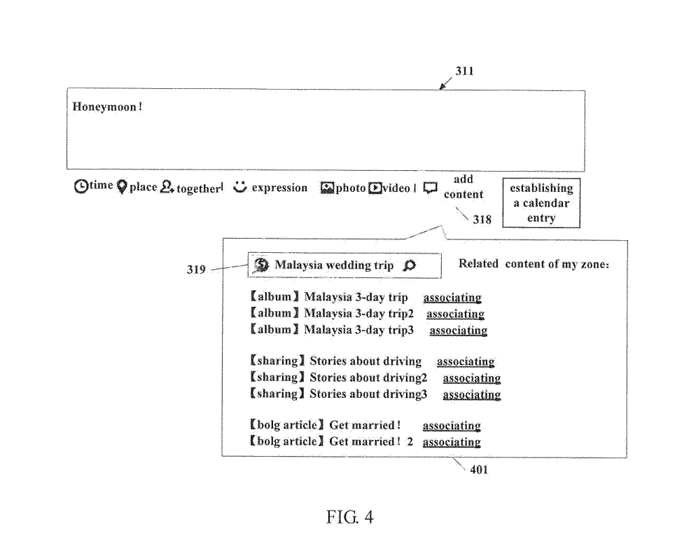

An “establishing a calendar entry” widget is provided in a user interface by the system. When the widget is clicked by the user, a calendar entry establishment request is trigged. A calendar entry establishment interface may be displayed when the calendar entry establishment request is received by the system. FIG. 3 is schematic diagram of an interface establishing a calendar entry according to an embodiment of present disclosure. Referring to FIG. 3, at least textual description 311 and time information 312 are noticed to be input by the user in an establishing interface of the calendar entry. The textual description and time information input by the user are recorded by the system to generate the calendar entry with the textual description and the time information. When the calendar entry is established, the system further notices the user to input geographical information (“location” in FIG. 3) 313, figure (“together” in the FIG.) 314, expression 315, photo 316, video 317 etc. When the “establishing a calendar entry” widget is clicked by the user, the information input by the user is recorded by the system and the calendar entry with the input information is generated.

Step 202, searching for a UGC matching the calendar entry and displaying the UGC on the interface.

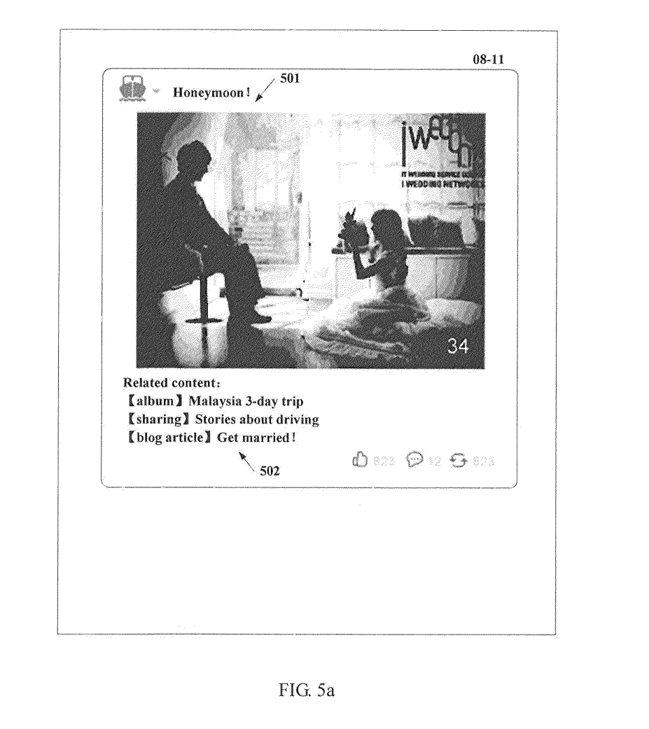

FIG. 4 is a schematic diagram of an interface displaying a found matched UGC when establishing a calendar entry according to an embodiment of present disclosure. Referring to FIG. 4, a widget 318 for trigger a search of a UGC matching the calendar is included in the establishing interface of the calendar entry. A search is trigged when the widget is clicked. A search scope includes blog articles, photos, sharing, microblogs etc. posted by the user and/or posted by the friends of the user or other calendar entry established by the user and the friends of the user. That is, the calendar entry may be associated with other calendar entry. A content of the found UGC is displayed in a displaying box 401.

The search of a UGC matched with the calendar entry includes as follows.

A UGC which time information matches a preset matching rule with the time information is searched; and/or a keyword of the calendar entry textual description (such as FIG. 4 shows a displaying content displayed in the displaying box 319 are keywords extracted from the calendar entry textual description) is extracted, the UGC which keyword matches with a preset matching rule is searched. If the calendar entry further includes geographical information, further the UGC which geographical information matches with the preset matching rule is searched for.

The preset matching rule may be preset and stored, and present and stored according to a business requirement. For example, a matching rule of time information may be set: searching the UGC happened in a same day (or a same week, or other time period) with the calendar entry; a matching rule of the keyword may be set: searching the UGC which content includes the keyword; a matching rule of the geographical information may be set: searching the UGC which content includes the geographical information, etc.

The detail method of extracting a keyword of the calendar entry textual description can use various keyword extracting algorithms, it is not described in detail in the present disclosure.

Step 203, receiving a selection command for the selecting the UGC by the user from the interface.

In FIG. 4, matched UGC information being found is displayed in the displaying box 401, and an “associating” linkage or widget is displayed beside the UGC information. When the “associating” linkage or widget is clicked by the user, a selection command is determined to be posted by the user, and the UGC is associated with the calendar entry. A detailed association process is described as follows.

Summary information of the associated UGC (such as, a title of the UGC, a first sentence, or keyword information extracted by a keyword extracting algorithm, etc.) is extracted, the summary information of the UGC is stored as a attachment of associating calendar entry. If a UGC is associated with several UGCs, then the calendar entry includes several attachments formed by summary information.

Step 204, displaying the calendar entry and information of the UGC associated with the calendar entry on the interface.

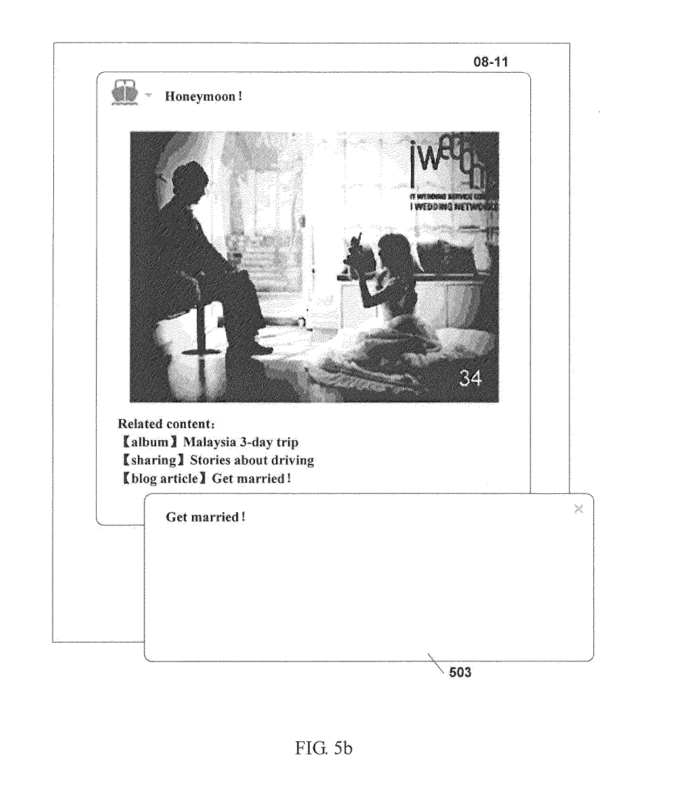

In the step, the detail method of displaying the calendar entry and the information of the UGC associated with the calendar entry is as follows. The calendar entry and the information of the UGC associated with the calendar entry are displayed on an interface of both the calendar entry creator and the friends of the calendar entry creator. Such as the interface displaying the calendar entry and the information of the UGC associated with the calendar entry shown in the FIG. 5a and FIG. 5b. Referring to FIG. 5a, when the calendar 501 is shown by the system, the attachments of the calendar entry is read, that is the summary information of the associated UGC is read, and the summary information of the associated UGC is displayed. When an item of summary information of a UGC is clicked by a user, detail information of the UGC is read and displayed. As shown in FIG. 5b, the last UGC is clicked, and the detail information 503 of the UGC is read and displayed.

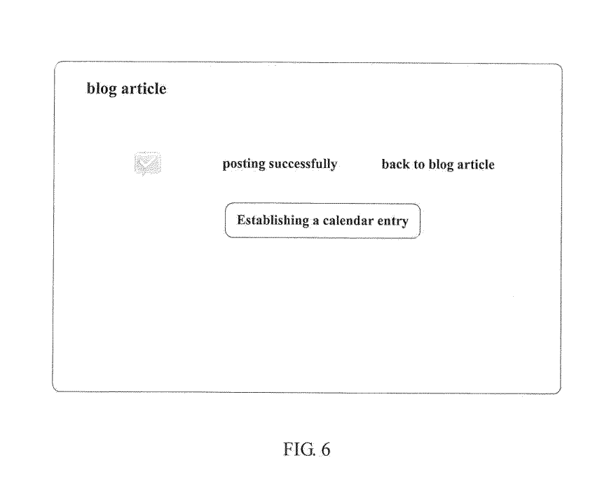

The embodiment of the present disclosure shown in FIG. 2 is trigged to execute when a request of establishing a calendar entry being triggered by the user is received. In other embodiment, the request of establishing a calendar entry is automatically triggered after the UGC is established. The embodiment includes: receiving an UGC establishing request of the user (such as a request of establishing a weblog or a request of uploading a picture) and establishing an UGC; prompting the user to establish a calendar entry as shown in FIG. 6, when a weblog is posted successfully (or established), a “establishing a calendar entry” widget is displayed, when the “establishing a calendar entry” widget is clicked by the user, the step 201 to step 203 are implemented to further guide the user to add other fragmented and non-associated UGCs which are the user's and the friends of the user; then, associating the UGC with the calendar entry established by the user. Lastly, the step 204 is implemented.

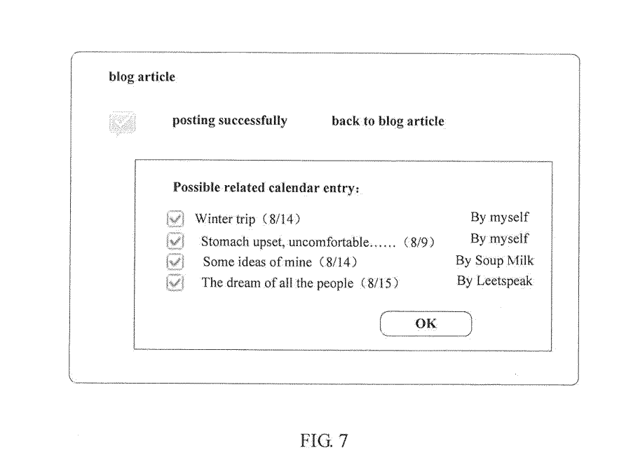

In other embodiment, when the calendar entry is established by the user and/or friends of the user, after the step of receiving an UGC establishing request of the user, the method further includes: establishing an UGC requested to be established by the user, then inquiring and displaying the information of calendar entry established by the user and the friends of the user as shown in FIG. 7; receiving the selection command of the displayed information of the calendar entry, associating the calendar entry selected by the user with the UGC established by the user, then further displaying the latest summary information of the UGC when the calendar entry is displayed next time.

Further, in present disclosure, the calendar entry is added with timestamp when the calendar entry is established. The timestamp is updated when the UGC is established and the UGC is associated with the calendar entry. The calendar entries are displayed in order of the timestamps when the calendar entries are displayed on the interface of both the calendar entry creator and the friends of the calendar entry creator. That is, the calendar entry with the latest timestamp is displayed in front. With this processing, once the UGC is established and associated with the calendar entry by the user, the timestamp is updated, the calendar entry is set top again in the interface of both the user and the friends of the user, and an update effect is achieved. The related content is spread by attracting the user to associate the related content, and is exposed in the front especially in the user interface including multiple UGC messages.

A device for processing the UGC is disclosed in present disclosure. The device comprises one or more processors, and a memory storing one or more program modules, the one or more programs including instructions for the above described method for processing the UGC.

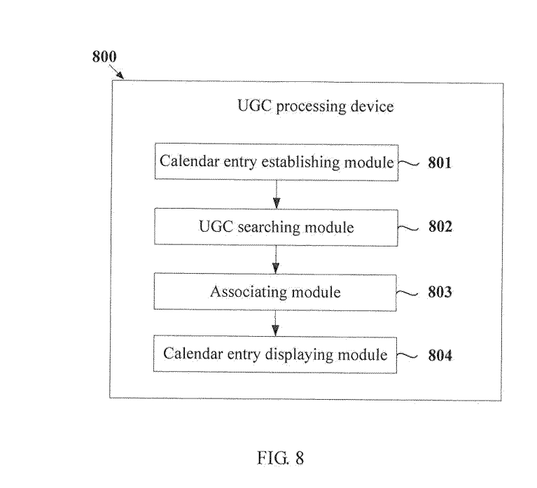

FIG. 8 is a structure schematic diagram of a device for processing the UGC according to an embodiment of present disclosure. Referring to FIG. 8, the device 800 includes the following modules.

A calendar entry establishing module 801, which is configured to provide an interface, receive a calendar entry establishment request of a user to establish a calendar entry on the interface.

A UGC searching module 802, which is configured to search for a UGC matching the calendar entry, and display the UGC which is found on the interface.

An associating module 803, which is configured to receive a selection command for selecting the UGC by the user from the interface, and associate the UGC selected by the user with the calendar entry.

A calendar entry displaying module 804, which is configured to display the calendar entry and information of the UGC associated with the calendar entry on the interface.

A detail function of each module may refer to the embodiment of the method described above, it is not described here.

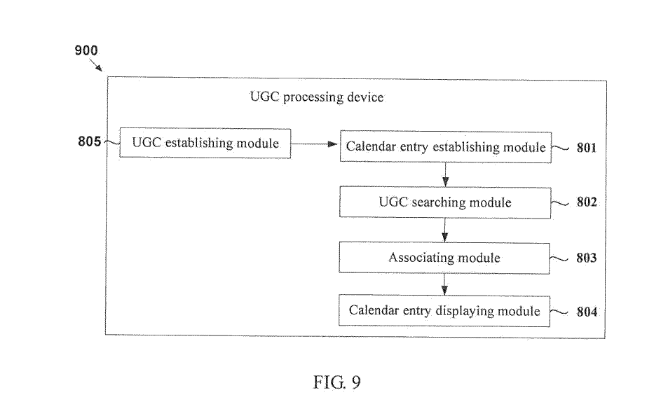

FIG. 9 is a structure schematic diagram of a device for processing the UGC according to another embodiment of present disclosure. Referring to FIG. 9, the device includes: a calendar entry establishing module 801, a UGC searching module 802, an associating module 803, a calendar entry displaying module 804 and a UGC establishing module 805. The calendar entry establishing module 801, the UGC searching module 802, the associating module 803, and the calendar entry displaying module 804 has the same function with corresponding module in FIG. 8, they are not described in detail here. The UGC establishing module 805 is configured to receive a UGC establishing request of the user, establish the UGC, and prompt the user to establish the calendar entry after the UGC is established.

The UGC establishing module 805 is further configured to search the calendar entry established by the user and/or the friends of the user after the UGC is established, and display the searched information of the calendar entry. The associating module 803 is further configured to receive the selection command of the user displayed by the UGC establishing module 805, associate the calendar entry selected by the user with the UGC established by the user, then, further display the latest summary information of the UGC when displaying the UGC again.

In embodiment of present disclosure, each module may be realized by software (such as computer readable instruction stored in memory), also may be realized by hardware (such as a processor of ASIC), or may be realized by a combination of software and hardware.

The embodiment of present disclosure may be realized by a combination of software and hardware. For example, each method, step and each function module described in the embodiment of present disclosure may be realized by a processor (The processor referred to here means broader processor, such as, CPU, processing unit, ASIC, logic unit, programmable logic unit, etc.). The process, method, and function module described in the embodiment of present disclosure may be realized by an individual processor or be realized by several processors. The processor in the embodiment of present disclosure or described in the claim may be understood as one processor or several processors. Moreover, the embodiment described may be realized by software production. The software production is stored in non-volatile storage media and includes a series of instruction to make a computer device (such as personal computer, server or network equipment) to implement the method described in the embodiment of present disclosure.

The drawings in the embodiment of present disclosure are only embodiments, some modules and steps are not necessary to realize the present disclosure. The modules may be combined to a module or be divided into several sub-modules.

While the present disclosure has been described with reference to particular embodiments, it will be understood that the embodiments are illustrative and that the invention scope is not so limited. Alternative embodiments of the present invention will become apparent to those having ordinary skill in the art to which the present invention pertains. Such alternate embodiments are considered to be encompassed within the spirit and scope of the present disclosure. Accordingly, the scope of the present invention is described by the appended claims and is supported by the foregoing description.

1. A method for processing a user generated content (UGC), comprising:
at a device having one or more processors and a memory for storing one or more programs to be executed by the one or more processors;
providing an interface;
receiving a calendar entry establishment request of a user, and establishing a calendar entry on the interface;
searching for a UGC matching the calendar entry, and displaying the UGC on the interface;
receiving a selection command for selecting the UGC from the interface, and associating the UGC selected with the calendar entry; and
displaying the calendar entry and information of the UGC associated with the calendar entry on the interface.

2. The method according to claim 1, wherein the step of receiving a calendar entry establishment request of a user, and establishing a calendar entry on the interface, comprises:
noticing the user to input time information and textual description, recording the time information and the textual description input by the user, and generating the calendar entry with the textual description and the time information;
the step of searching for a UGC matching the calendar entry, comprises:
searching for a UGC which matches a preset matching rule with the time information; and/or
extracting a keyword of the textual description and searching for the UGC which matches with the preset matching rule with the keyword.

3. The method according to claim 1, wherein the step of receiving a calendar entry establishment request of a user, and establishing a calendar entry on the interface, further comprises:
noticing the user to input geographical information, recording the geographical information input by the user; generating a calendar entry with the geographical information;
the step of searching for a UGC matching the calendar entry further comprises:
searching for a UGC which matches a preset matching rule with the geographical information.

4. The method according to claim 1, further comprising:
noticing the user to establish the calendar entry, after receiving the UGC establishing request of the user and establishing the UGC; and
associating the UGC established by the user with the calendar entry after establishing the calendar entry.

5. The method according to claim 1, further comprising:
displaying the calendar entry established by the user and/or the user's friends after receiving a UGC establishing request of the user and establishing the UGC; and
receiving a selection command for the calendar entry of the user, and associating the calendar entry selected by the user with the UGC established by the user.

6. The method according to claim 1, wherein the step of displaying the calendar entry and the information of the UGC associated with the calendar entry, comprises:
displaying the calendar entry and the information of the UGC associated with the calendar entry on interfaces of both a calendar entry establisher and friends of the calendar entry establisher.

7. The method according to claim 6, comprising:
adding timestamp on the calendar entry when establishing the calendar entry;
updating the timestamp when establishing the UGC and associating the UGC with the calendar entry; and
scheduling calendar entries displayed in order of timestamps when displaying the calendar entries on the interfaces of both the calendar entry establisher and the friends of the calendar entry establisher.

8. A device for processing a user generated content (UGC), wherein the device comprises:
one or more processors;
a memory storing one or more program modules configured for execution by the one or more processors, the one or more program modules comprising instructions for:
a calendar entry establishing module, configured to provide an interface, receive a calendar entry establishment request of a user to establish a calendar entry on the interface;
a UGC searching module, configured to search for a UGC matching the calendar entry, and display the UGC on the interface;
an associating module, configured to receive a selection command for selecting the UGC by the user from the interface, and associate the UGC selected with the calendar entry; and
a calendar entry displaying module, configured to display the calendar entry and information of the UGC associated with the calendar entry on the interface.

9. The device according to claim 8, wherein the calendar entry establishing module is further configured to notice the user to input time information and textual description, record the time information and textual description input by the user, and generate the calendar entry with the textual description and the time information;
the UGC searching module is further configured to search a UGC which matches a preset matching rule with the time information; and/or
extract a keyword of the textual description and search for the UGC which matches the preset matching rule with the key.

10. The device according to claim 8, wherein the calendar entry establishing module is further configured to notice the user to input geographical information, recording the geographical information input by the user; generating a calendar entry with the geographical information;
the UGC searching module is further configured to search for a UGC which matches with a preset matching rule with the geographical information.

11. The device according to claim 8, further comprising: a UGC establishing module configured to notice the user to establishing the calendar entry after receiving the UGC establishing request of the user, and establishing the UGC;
the associating module is further configured to associate the UGC established by the user with the calendar entry after the calendar entry establishing module establishing the calendar entry.

12. The device according to claim 8, further comprising: a UGC establishing module configured to display the calendar entry established by the user and/or the user's friends after receiving a UGC establishing request of the user and establishing the UGC; and
the associating module is further configured to receive a selection command for the calendar entry of the user displayed by the UGC establishing module, and associate the calendar entry selected by the user with the UGC established by the user.

13. The device according to claim 8, wherein calendar entry displaying module is further configured to display the calendar entry and the information of the UGC associated with the calendar entry on interfaces of both the calendar entry establisher and friends of the calendar entry establisher.

14. The device according to claim 13, wherein the calendar entry establishing module is further configured to add timestamp on the calendar entry when establishing the calendar; the associating module is further configured to updating the timestamp when establishing the UGC and associating the UGC with the calendar entry;
the calendar entry displaying module is further configured to schedule the calendar entries displayed in order of the timestamps when displaying the calendar entries on the interfaces of both the calendar entry establisher and the friends of the calendar entry establisher.

15. A non-volatile non-transitory computer storage media medium, storing one or more programs for execution by one or more processor and a memory, the one or more programs comprising instructions for:
providing an interface;
receiving a calendar entry establishment request of a user, and establishing a calendar entry on the interface;
searching for a UGC matching the calendar entry, and displaying the UGC on the interface;
receiving a selection command for selecting the UGC from the interface, and associating the UGC selected with the calendar entry; and
displaying the calendar entry and information of the UGC associated with the calendar entry on the interface.

16. The non-volatile non-transitory computer storage media medium according to claim 15, wherein the step of receiving a calendar entry establishment request of a user, and establishing a calendar entry on the interface, comprises:
noticing the user to input time information and textual description, recording the time information and the textual description input by the user, and generating the calendar entry with the textual description and the time information;
the step of searching for a UGC matching the calendar entry, comprises:
searching for a UGC which matches a preset matching rule with the time information; and/or
extracting a keyword of the textual description and searching for the UGC which matches with the preset matching rule with the keyword.

17. The non-volatile non-transitory computer storage media medium according to claim 15, wherein the step of receiving a calendar entry establishment request of a user, and establishing a calendar entry on the interface, comprises:
noticing the user to input geographical information, recording the geographical information input by the user; generating a calendar entry with the geographical information;
the step of searching for a UGC matching the calendar entry further comprises: searching for a UGC which matches a preset matching rule with the geographical information.

18. The non-volatile non-transitory computer storage media medium according to claim 15, the non-transitory computer readable storage medium storing computer-executable instructions that, when executed by a processor, further perform a method comprising steps of:
noticing the user to establish the calendar entry, after receiving the UGC establishing request of the user and establishing the UGC; and
associating the UGC established by the user with the calendar entry after establishing the calendar entry.

19. The non-volatile non-transitory computer storage media medium according to claim 15, the non-transitory computer readable storage medium storing computer-executable instructions that, when executed by a processor, further perform a method comprising steps of:
displaying the calendar entry established by the user and/or the user's friends after receiving a UGC establishing request of the user and establishing the UGC; and
receiving a selection command for the calendar entry of the user, and associating the calendar entry selected by the user with the UGC established by the user.

20. The non-volatile non-transitory computer storage media medium according to claim 15, wherein the step of displaying the calendar entry and the information of the UGC associated with the calendar entry, comprises:
displaying the calendar entry and the information of the UGC associated with the calendar entry on interfaces of both a calendar entry establisher and friends of the calendar entry establisher.

21. The non-volatile non-transitory computer storage media medium according to claim 20, the non-transitory computer readable storage medium storing computer-executable instructions that, when executed by a processor, further perform a method comprising steps of:
adding timestamp on the calendar entry when establishing the calendar entry;
updating the timestamp when establishing the UGC and associating the UGC with the calendar entry; and
scheduling the calendar entries displayed in order of the timestamps when displaying the calendar entries on the interfaces of both the calendar entry establisher and the friends of the calendar entry establisher.
